(19) United States
(12) Patent Application Publication
(10) Pub. No.: US 2026/0362506 A1
(43) Pub. Date: Nov. 12, 2026

(54) CONTENTION-BASED RANDOM ACCESS RESPONSE MESSAGE CONFIGURATION

(71) Applicant: QUALCOMM Incorporated, San Diego, CA (US)

(72) Inventors: Harikumar KRISHNAMURTHY, San Diego, CA (US); Umesh PHUYAL, San Diego, CA (US); Ayan SENGUPTA, Mountain View, CA (US); Bharat SHRESTHA, San Diego, CA (US); Alberto RICO ALVARINO, San Diego, CA (US)

(21) Appl. No.: 19/458,453

(22) Filed: Jan. 23, 2026

Related U.S. Application Data
(60) Provisional application No. 63/802,329, filed on May 8, 2025.

(51) Int. Cl. H04W 74/0836; H04L 69/22

(52) U.S. Cl. CPC H04W 74/0836; H04L 69/22

(57) ABSTRACT

This disclosure provides methods, components, devices and systems for contention-based random access response message configuration. For example, a user equipment (UE) that is a narrowband Internet of Things device (NB-IoT) may transmit, as part of a two-step random access channel (RACH) procedure, a contention-based random access message in a resource of a transmission occasions of a set of transmission occasions. In response, the UE may receive, during the two-step RACH, a response message that includes one or more sub-headers that are indicated consecutively and prior to a payload portion of the response message. Therefore, by utilizing a similar configuration for the sub-headers and the payload portion as used by non-NB-IoT devices and ensuring that the sub-headers of the response message are indicated prior to the payload portion, the UE may be capable of utilizing a two-step RACH procedure for establishing a connection with a network entity.

### CROSS REFERENCES

The present application for patent claims benefit of U.S. Provisional Patent Application No. 63/802,329 by KRISHNAMURTHY et al., entitled “CONTENTION-BASED RANDOM ACCESS RESPONSE MESSAGE CONFIGURATION,” filed May 8, 2025, assigned to the assignee hereof, and expressly incorporated by reference herein.

### TECHNICAL FIELD

This disclosure relates generally to wireless communication, and more specifically to systems, devices, methods, and techniques associated with contention-based random access response message configuration.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include transmitting, via at least one transmission occasion in a group of transmission occasions, at least one contention-based random access message using a resource from a set of resources of the at least one transmission occasion and receiving, in response to transmitting the at least one contention-based random access message, at least one response message that corresponds to one or more UEs that include the UE, the at least one response message including one or more sub-headers that are indicated consecutively and prior to a payload portion of the at least one response message, where the one or more sub-headers include one or more bits indicative of a sub-header type.

A UE for wireless communications is described. The UE may include a processing system that includes processor circuitry and memory circuitry that stores code. The processing system may be configured to cause the UE to transmit, via at least one transmission occasion in a group of transmission occasions, at least one contention-based random access message using a resource from a set of resources of the at least one transmission occasion and receive, in response to transmitting the at least one contention-based random access message, at least one response message that corresponds to one or more UEs that include the UE, the at least one response message including one or more sub-headers that are indicated consecutively and prior to a payload portion of the at least one response message, where the one or more sub-headers include one or more bits indicative of a sub-header type.

Another UE for wireless communications is described. The UE may include means for transmitting, via at least one transmission occasion in a group of transmission occasions, at least one contention-based random access message using a resource from a set of resources of the at least one transmission occasion and means for receiving, in response to transmitting the at least one contention-based random access message, at least one response message that corresponds to one or more UEs that include the UE, the at least one response message including one or more sub-headers that are indicated consecutively and prior to a payload portion of the at least one response message, where the one or more sub-headers include one or more bits indicative of a sub-header type.

A non-transitory computer-readable medium storing code for wireless communications is described. The code may include instructions executable by one or more processors to transmit, via at least one transmission occasion in a group of transmission occasions, at least one contention-based random access message using a resource from a set of resources of the at least one transmission occasion and receive, in response to transmitting the at least one contention-based random access message, at least one response message that corresponds to one or more UEs that include the UE, the at least one response message including one or more sub-headers that are indicated consecutively and prior to a payload portion of the at least one response message, where the one or more sub-headers include one or more bits indicative of a sub-header type.

Some examples of the method, UEs, and non-transitory computer-readable medium described herein may further include operations, features, means, or instructions for receiving, via the one or more sub-headers indicated via the at least one response message, a first sub-header that includes one or more bits indicating that the sub-header type of the first sub-header may be a contention-based random access message failure sub-header type, the one or more bits of the first sub-header indicating that the first sub-header corresponds with a first sub-payload within the payload portion that includes a retransmission request for the at least one contention-based random access message transmitted by the UE.

In some examples of the method, UEs, and non-transitory computer-readable medium described herein, the one or more bits of the first sub-header includes an indication of a first field with a corresponding value that may be indicative of a presence of one or more additional sub-headers within the at least one response message, an indication of a second field with a corresponding value that may be indicative of a presence of an identifier of the UE that corresponds to the at least one contention-based random access message, an indication of the identifier of the UE, or any combination thereof.

In some examples of the method, UEs, and non-transitory computer-readable medium described herein, the identifier of the UE may be based on the resource from the set of resources of the at least one transmission occasion that the UE used to transmit the at least one contention-based random access message, an orthogonal cover code resource, and the at least one transmission occasion that the UE used to transmit the at least one contention-based random access message.

Some examples of the method, UEs, and non-transitory computer-readable medium described herein may further include operations, features, means, or instructions for receiving, via the first sub-payload within the payload portion, an indication of whether the retransmission request indicates a retransmission grant or an fallback indication, a timing advance command, an uplink grant, a temporary network identifier, or any combination thereof.

Some examples of the method, UEs, and non-transitory computer-readable medium described herein may further include operations, features, means, or instructions for receiving, via the one or more sub-headers indicated via the at least one response message, a first sub-header that includes one or more bits indicating that the sub-header type of the first sub-header may be a backoff indicator sub-header type, the one or more bits of the first sub-header including an indication of a first field with a corresponding value that may be indicative of a presence of one or more additional sub-headers within the at least one response message, an indication of a second field with a corresponding value that may be indicative of a backoff indicator, or a combination thereof, where the backoff indicator includes an indication of a duration for the UE to retry the at least one contention-based random access message.

Some examples of the method, UEs, and non-transitory computer-readable medium described herein may further include operations, features, means, or instructions for receiving, via the one or more sub-headers indicated via the at least one response message, a first sub-header includes one or more bits indicating that the sub-header type of the first sub-header may be a contention-based random access message success sub-header type, the one or more bits of the first sub-header indicating that the first sub-header corresponds with a first sub-payload within the payload portion that includes an indication of a successful reception of the at least one contention-based random access message.

In some examples of the method, UEs, and non-transitory computer-readable medium described herein, the one or more bits of the first sub-header includes an indication of a first field with a corresponding value that may be indicative of a presence of one or more additional sub-headers within the at least one response message, an indication of a second field with a corresponding value that may be indicative of a presence of a third field, an indication of the third field with a corresponding value that may be indicative of a presence of a service data unit (SDU) indicator, an indication of a fourth field with a corresponding value that may be indicative of a presence of a SDU sub-header subsequent to the first sub-header, or any combination thereof.

In some examples of the method, UEs, and non-transitory computer-readable medium described herein, the first sub-header, the first sub-payload, or both includes an indication whether the UE should switch to a different power saving state.

In some examples of the method, UEs, and non-transitory computer-readable medium described herein, a first sub-payload of the payload portion of the at least one response message includes a timing advance command that indicates a timing advance modification value.

Some examples of the method, UEs, and non-transitory computer-readable medium described herein may further include operations, features, means, or instructions for receiving, via a first sub-payload of the payload portion of the at least one response message, an indication of a radio network identifier for subsequent communications, the radio network identifier being based on a maximum quantity of carriers, a system frame number (SFN), a hyper-SFN (H-SFN), or any combination thereof.

In some examples of the method, UEs, and non-transitory computer-readable medium described herein, the at least one contention-based random access message indicates a data signal transmission, a connection establishment request, or both.

In some examples of the method, UEs, and non-transitory computer-readable medium described herein, the at least one response message corresponds to the one or more UEs based on the at least one response message being a multicast message.

In some examples of the method, UEs, and non-transitory computer-readable medium described herein, the UE may be a narrow-band Internet of Things (NB-IoT) device.

### BRIEF DESCRIPTION OF THE DRAWINGS

FIG. 1 shows an example of a wireless communication system.

FIG. 2 shows an example of a signaling diagram that supports a contention-based random access response message configuration.

FIG. 3 shows an example of a process flow that supports a contention-based random access response message configuration.

FIG. 4 shows a block diagram of a processing system that supports a contention-based random access response message configuration.

FIG. 5 shows a diagram of a system including a device that supports a contention-based random access response message configuration.

FIG. 6 shows a flowchart illustrating methods that support contention-based random access response message configuration.

FIG. 7 shows a flowchart illustrating methods that support contention-based random access response message configuration.

Details of aspects and advantages of the subject matter in this disclosure are set forth in the drawings and accompanying descriptions. Like reference numbers and designations in the various drawings indicate like elements.

Additional disclosure and examples related to the present description is provided in the attached appendix which is incorporated by reference in its entirety.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, physical random-access channel (PRACH) resources may be configured during a random-access channel (RACH) occasion (e.g., a transmission occasion for a RACH preamble or data transmission) for a user equipment (UE) to initiate a RACH procedure or to perform a RACH-less early data transmission (EDT) using the PRACH resources in the RACH occasion. The PRACH resources may generally be shared resources that are available to any UE for initiating the RACH procedure or sending the EDT to the network. For example, each UE may randomly select one of the PRACH resources (e.g., preambles) to send an access signal to the network according to the PRACH configuration. However, in some examples multiple UE may select the same resource and transmit access signals to the network during the RACH occasion. This may result in a collision of the access signal transmissions, which may introduce delays and disrupt communications between the UE and the network. To avoid such collision, UEs may be configured with a contention-based RACH procedure where a UE is configured with multiple transmission occasions where each transmission occasion is configured with a set of resources for the UE to use for transmitting random access messages (e.g., data or access signals).

In some examples, the contention-based RACH procedure may be a four-step RACH procedure or a two-step RACH procedure where the messages from the UE and the network entity are combined into two messages rather than four messages. For example, the four-step RACH procedure may include a UE transmitting a message 1, a network entity receiving the message 1 and transmitting a message 2, the UE receiving the message 2 and transmitting a message 3, and the network entity receiving the message 3 and transmitting a message 4. In the two-step RACH procedure, the UE may combine the message 1 and the message 3 into a single message (e.g., a message A) that is transmitted to the network entity and the network entity may respond with a single message (e.g., a message B) that is a combination of the message 2 and the message 4.

In some cases, a UE may be a NB-IoT device and may be configured with a contention-based RACH procedure for NB-IoT devices. In some examples, the contention-based RACH procedure for NB-IoT devices may be an example of a four-step RACH procedure. In some cases, the four-step RACH procedure for NB-IoT devices may be relatively similar to the four-step RACH procedure used by non-IoT UEs. However, in an NB-IoT message 3 (e.g., a random access response message), each sub-header of the message may be indicated before a payload of a message. Further, a four-step RACH procedure may be relatively time consuming and may result in a relatively larger resource and power consumption compared to a two-step RACH procedure. However, NB-IoT devices may have relatively low power levels and the power consumption levels associated with the four-step RACH procedure may increase the latency associated with the four-step RACH procedure. Thus, the four-step RACH procedure for NB-IoT devices may cause additional delays in establishing a connection between a UE and a network entity which can result in a decrease in efficiency and reliability of a wireless network.

Aspects of the subject matter described in this disclosure relate to a two-step RACH procedure for NB-IoT devices that is similar to and based on the two-step RACH procedure for non-NB-IoT devices. For example, a UE that is a NB-IoT device may transmit a contention-based random access message in a resource of a transmission occasion of a set of transmission occasions. In response, the UE may receive a response message that includes one or more sub-headers that are indicated consecutively and prior to a payload portion of the response message. Therefore, the response message for the two-step RACH procedure for NB-IoT devices may include a relatively similar structure as a random access response message in the four-step RACH procedure for NB-IoT devices by ensuring that the sub-headers of the response message are indicated prior to any payload portion of the response message. Moreover, the two-step RACH procedure for NB-IoT devices may utilize the configuration of the two-step RACH procedure for non-NB-IoT devices. For example, the sub-headers of the response message in the two-step RACH procedure for NB-IoT devices may include similar fields as those in the two-step RACH procedure for non-NB-IoT devices. Additionally, or alternatively, the sub-payloads associated with the sub-headers in the two-step RACH procedure for NB-IoT devices may include similar information and data as those in the two-step RACH procedure for non-NB-IoT devices. Therefore, NB-IoT devices may be capable of utilizing a two-step RACH procedure over a four-step RACH procedure in a relatively similar fashion as non-NB-IoT devices.

Particular aspects of the subject matter described in this disclosure can be implemented to realize one or more of the following potential advantages. In some examples, by ensuring that the format of the response message in the four-step RACH procedure for the NB-IoT devices is maintained in the two-step RACH procedure for the NB-IoT devices, the described techniques can be used to enable NB-IoT devices to use a relatively similar configuration as the configuration utilized by non-NB-IoT devices which can reduce changes to device implementations. In some cases, by utilizing a configuration for the sub-headers and the sub-payloads for the response message that are similar to the two-step RACH procedure response message for non-NB-IoT devices, the described techniques can be used to implement the two-step RACH procedure for NB-IoT devices which can be used to improve the performance of NB-IoT devices. For example, by ensuring that the sub-headers of the response message are indicated prior to any payload portion of the response message, the NB-IoT devices may be capable of using the response message for implementing the two-step RACH procedure for NB-IoT devices, which may be more efficient that of the four-step RACH procedure.

For example, implementing a two-step RACH procedure for NB-IoT devices may result in an increase of power savings for NB-IoT devices during the RACH procedure due to a reduction of signaling overhead. Implementing the two-step RACH procedure for NB-IoT devices may also result in a decrease in latency associated with random access connections for NB-IoT devices due to the reduction in time corresponding to processing and the reduction in the signaling overhead. Such decrease in latency for connecting with a network entity may also result in a decrease in latency of communications due to relatively faster establishments of connections, thus improving the overall efficiency and reliability of an NB-IoT device. Additionally, or alternatively, since NB-IoT devices may have relatively low battery levels and processing capabilities, reducing the power consumption and signaling overhead for the RACH procedures can improve the performance of the RACH procedures by reducing the processing complexity and preventing more frequent recharging. Further, the use of a two-step RACH procedure may ensure that NB-IoT devices can connect to a network entity relatively more accurately, efficiently, and reliably. Therefore, the described techniques of implementing a two-step RACH procedure for NB-IoT devices may improve the overall performance of a wireless communication system that includes NB-IoT devices.

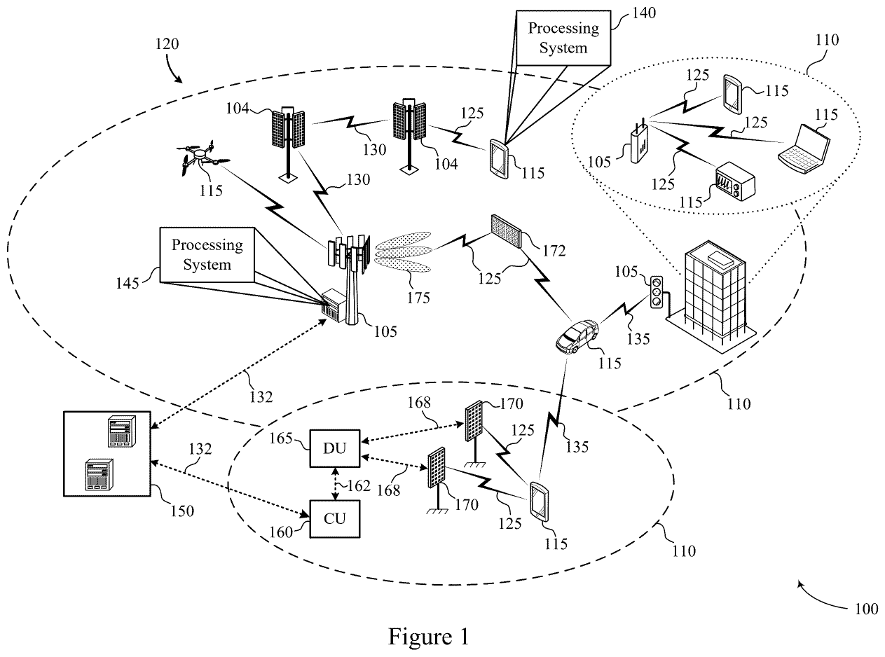

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, where the device may provide HARQ feedback in a specific slot for data received via a previous symbol of the slot. In some other examples, the device may provide HARQ feedback via a subsequent slot or according to some other time interval.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

Some UEs 115, such as MTC or IoT devices, may be relatively low cost or low complexity devices and may provide for automated communication between machines. MTC may refer to data communication technologies that allow devices to communicate with one another or a network entity 105 without human intervention. In some examples, MTC may include communications from devices that collect information and relay such information to a central server or application program that uses the information or presents the information to humans interacting with the application program. Examples of applications for IoT devices include asset management (e.g., inventory monitoring, water level monitoring, equipment monitoring, healthcare monitoring, wildlife monitoring, fleet management and tracking), smart metering, weather and geological event monitoring, remote security sensing, physical access control, and transaction-based business charging. For example, IoT devices may integrate sensors to measure or capture information including location parameters (e.g., geolocation, orientation) or environmental conditions (e.g., temperature, humidity, pressure, impact) of an asset, where the IoT device is connected electronically or mechanically to the asset.

In some examples, the wireless communications system 100 may use a non-terrestrial device, a non-terrestrial network (NTN), or an aerial platform to support a coverage area 110. NTNs may be examples of networks or segments of networks that utilize non-terrestrial devices (e.g., satellites, aerial platforms) to support communication between network entities 105 and UEs 115. A satellite may be deployed in a variety of orbits to support an NTN, including a low earth orbit (LEO), a medium earth orbit (MEO), a geostationary earth orbit (GEO), a highly elliptical orbit (HEO), or any combination thereof. An aerial platform, such as an unmanned aerial vehicle (UAV) or a high altitude platform (HAP), may be an example of a network entity 105, a UE 115, or both operating above the ground, and the aerial platform can be capable of moving within a geographic area or between geographic areas. In some examples, the wireless communications system 100 may use satellites and aerial platforms to extend the coverage of a coverage area 110. For example, the wireless communications system 100 may implement one or more satellites, one or more aerial platforms, or both to increase the size of a coverage area 110 by supporting additional geographic areas over which a network entity 105 and a UE 115 may support the communication of signals according to one or more RATs.

Devices of the wireless communication system 100 may be configured to support one or more aspects of the described techniques for contention-based random access response message configuration. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support a two-step RACH procedure for NB-IoT devices that is associated with and based on the two-step RACH procedure for non-NB-IoT devices.

For example, in accordance with the techniques of the present disclosure, a UE 115 that is an NB-IoT device may transmit, to a network entity 105, a contention-based random access message in a resource of a transmission occasion of a set of transmission occasions. In response, the UE 115 may receive, from a network entity 105, a response message that includes one or more sub-headers that are indicated consecutively and prior to a payload portion of the response message. Therefore, in accordance with the techniques of the present disclosure, NB-IoT devices may be capable of utilizing a two-step RACH procedure over a four-step RACH procedure in a relatively similar fashion as the two-step RACH procedure for non-NB-IoT devices.

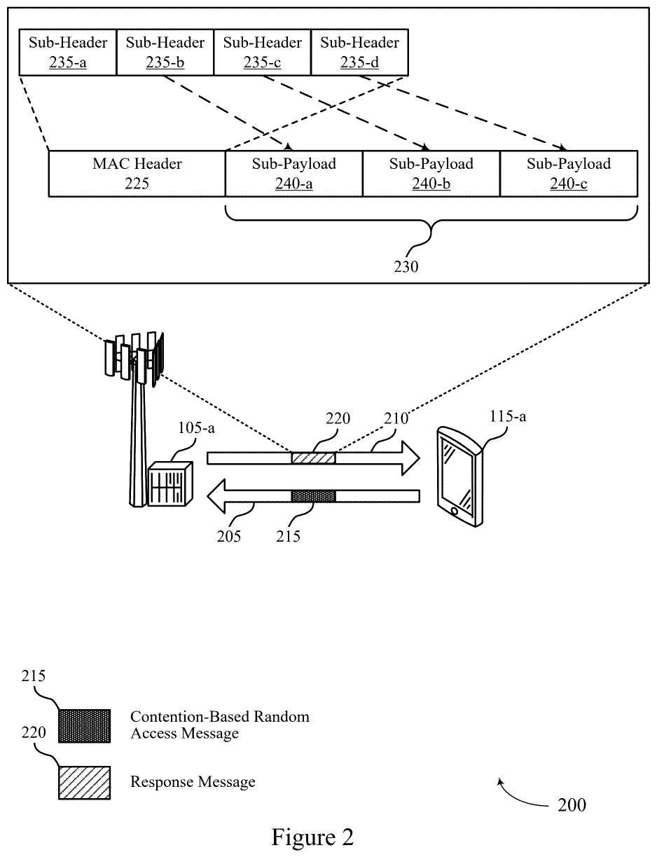

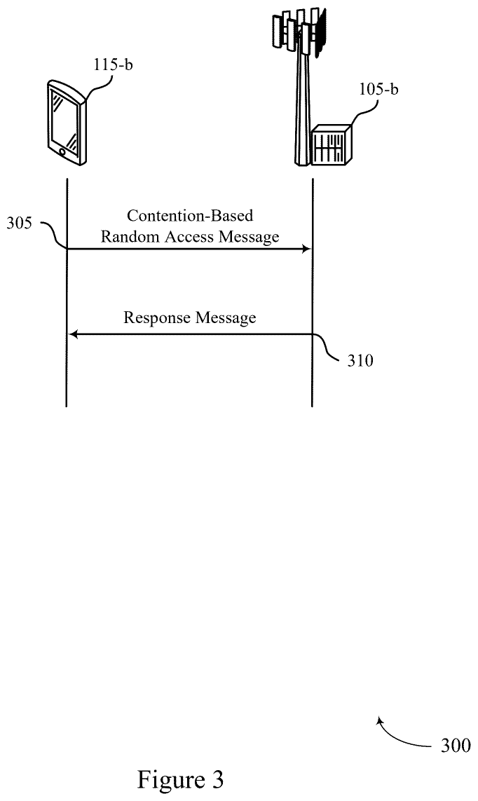

In some examples, an NB IoT device utilizing a two-step RACH procedure rather than a four-step RACH procedure may result in an increase of power savings for NB-IoT devices during the RACH procedure due to a reduction of signaling overhead. Further, utilization of the described two-step RACH procedure may also result in a decrease in latency associated with random access connections for NB-IoT devices which can result in a decrease in latency of communications due to relatively faster connection establishment, thus improving the overall efficiency and reliability of an NB-IoT device. Therefore, the techniques of the present disclosure of implementing a two-step RACH procedure for NB-IoT devices may improve the overall performance of the wireless communications system 100. Further descriptions of the techniques of the present disclosure for improving the performance of UEs 115 that are NB-IoT devices and improving the performance of the wireless communications system may be described elsewhere herein, such as with reference to FIGS. 2 and 3.

FIG. 2 shows an example of a signaling diagram 200 that supports a contention-based random access response message configuration. In some examples, the signaling diagram 200 may implement or be implemented by the wireless communications system 100. For example, the signaling diagram 200 may include a UE 115-a and a network entity 105-a, which may represent examples of corresponding devices described herein with reference to FIG. 1. The UE 115-a may communicate with the network entity 105-a via a communication link 205 and the network entity 105-a may communicate with the UE 115-a via a communication link 210. The communication link 205 and the communication link 210 may be an example of a type of communication link 125 described herein with reference to FIG. 1. For example, the communication link 205 may be an example of an uplink communication link and the communication link 210 may be an example of a downlink communication link. Further, the appendix included herein may be incorporated entirely within the techniques described herein within the description of the signaling diagram 200.

In some examples, wireless networks may utilize various access schemes to establish a connection between a UE 115 (e.g., the UE 115-a) and a network entity 105 (e.g., a network entity 105-a). In some cases, the access schemes may be contention-based or non-contention-based. Non-contention-based access schemes may include dedicated resources being configured for a UE to establish a connection to the network. Contention-based access schemes may include a pool of resources being established that are shared by all UE.

As one non-limiting example, a contention-based access scheme may include a four-step RACH procedure. The four-step RACH procedure may be initiated with the UE 115-a transmitting a first message (Msg1) with a RACH preamble to the network entity 105-a. For example, after choosing a RACH occasion the UE 115-a may uniformly and randomly choose a RACH preamble from a set of allowed RACH preambles. The UE 115-a may transmit the RACH preamble to the network entity 105-a that is scrambled with a random-access radio network temporary identifier (RA-RNTI). The UE 115-a may then wait for a random-access response (RAR) message from the network entity 105-a. In some aspects, the Msg1 transmission may carry or otherwise convey an indication of a random-access preamble identifier (RAPID) associated with the RACH process.

The network may respond to the Msg1 transmission by transmitting the RAR in a message two (Msg2). In some examples, the RAR message may be a multicast message that includes a payload (e.g., a MAC packet data unit PDU) with one or more sub-payloads (e.g., one or more MAC sub-PDUs) associated with one or more sub-headers (e.g., MAC sub-headers). For example, the RAR may include a first sub-header with a backoff indicator to indicate a time delay between random access transmissions, a second sub-header with a RAPID (e.g., to indicate a system information (SI) request acknowledgment), and a third sub-header with a RAPID and a MAC RAR. In some cases, each of the one or more sub-payloads of the RAR may include a respective sub-header followed by a corresponding payload portion as indicated via the respective sub-header.

In some examples, if UE 115-a is unable to detect a RAPID that the UE 115-a used for transmitting a random access preamble in the Msg1 transmission in a RAR message, the UE 115-a may wait until an end of the RAR window to obtain other RAR messages. In some cases, the UE 115-a may be unsuccessful in receiving an RAR with a matching RAPID for an entirety of the RAR window. In such cases, the UE 115-a may declare or indicate that the RAR reception was unsuccessful and proceed to increment a preamble transmission counter and delay any subsequent preamble transmission attempts based on a backoff time. In some examples, the increment to the preamble transmission counter may result in the preamble transmission counter satisfying a threshold. For example, the value of the preamble transmission counter may exceed a maximum preamble transmission counter threshold. In such examples, the UE 115 a may then declare and indicate that the random access procedure is unsuccessful.

If the UE 115-a does detect a RAPID match, the UE 115-a may receive and decode a MAC RAR sub-payload. For example, based on correctly receiving the preamble from the UE 115-a the network entity 105-a may respond with the RAPID as well as including other information for a message three (Msg3) transmission, such as a timing advance, uplink grant, and temporary cell radio network temporary identifier (TC-RNTI). In some examples, the information may be indicated within a MAC RAR sub-payload of a sub-PDU that includes indications of a timing advance command, the uplink grant, the TC-RNTI, or any combination thereof. In some cases, the uplink grant may indicate a set of time and frequency resources, a modulation and coding scheme (MCS), a transmit power control (TPC), or any combination thereof for the Msg3 transmission.

The UE 115-a may respond to the Msg2 transmission from the network entity 105-a by transmitting the Msg3. For example, if the RAR from the network entity 105-a includes the RAPID transmitted in the Msg1, the UE 115-a may transmit the Msg3 according to the uplink grant indicated in the Msg2. In some aspects, the Msg3 may be scrambled using the temporary C-RNTI and include a contention resolution identifier/C-RNTI (e.g., if the network entity 105-a has already assigned a permanent C-RNTI to the UE 115-a). Further, the network entity 105-a may correctly receive the Msg3 and resolve any contention, if any. The network entity 105-a may transmit a response (e.g., a message four (Msg4)) to the UE that includes the contention resolution identifier/C-RNTI of the successful UE. In some aspects, the network entity 105-a may also issue a retransmission of the Msg3 if required. Based on receiving the Msg4 with the matching contention resolution identifier it transmitted in Msg3, the UE 115-a may consider the contention resolution and the random-access procedure successful. The UE 115-a may then promote the temporary C-RNTI to the permanent C-RNTI (e.g., if not assigned earlier). In some aspects, the UE 115-a may transmit an acknowledgment of the Msg4 to the network entity.

In some cases, in response to the Msg3, the UE 115-a may receive, from the network entity 105-a, a downlink control message (e.g., a downlink control information (DCI) message) with one of two possible formats. For example, the UE 115-a may receive a DCI with a first DCI format (e.g., DCI format 0_0) or a second DCI format (e.g., DCI 1_0). In some cases, a DCI with the first DCI format may allocate the UE 115-a with uplink resources (e.g., physical uplink shared channel (PUSCH) resources) for a retransmission of the Msg3. Further, a DCI with the second DCI format may allocate the UE 115-a with downlink resources (e.g., physical downlink shared channel (PDCCH) resources) for transmission of the Msg4.

Another contention-based RACH procedure may include a two-step RACH procedure where Msg1 and Msg3 are combined into a message A (MsgA) and Msg2 and Msg4 are combined into a message B (MsgB). Such approach may reduce the latency associated with RACH procedure and reduce the signaling overhead of the RACH procedure. However, and similar to the four-step RACH procedure, if two or more UEs choose the same preamble they would be involved in a contention and at most one of those UEs would successfully receive a MsgB.

One variation of the two-step RACH procedure may include a RACH-less early data transmission (EDT) being used in NB-IoT communications over a non-terrestrial network (NT). In RACH-less EDT, the UE 115-a may directly transmit data in the first transmission (e.g., without preamble) by choosing the data resources (as opposed to choosing both data resources and preambles) from a pool of data resources for contention-based transmission. The UE 115-a may then wait for a response to the data transmission within a time window. This technique may be feasible in NTNs when the UE 115-a are GNSS-capable and have location information of the UE 115-a and the satellite (e.g., from the satellite ephemeris). However, even in this situation the collision discussed above may be applicable. That is, if two or more UEs 115 choose the same data resource (e.g., corresponding to the preamble resource discussed above) for transmission of the RACH-less EDT, there will likely be a collision at the network entity 105-a and the random access will fail (e.g., the RACH-less EDT transmission will fail).

Further, while NB-IoT devices (e.g., the UE 115-a) may utilize a two-step procedure for the RACH-less EDT procedure, RACH procedures for NB-IoT devices may otherwise be limited to a four-step RACH procedure. Moreover, NB-IoT RACH procedures may be different compared to RACH procedures without NB-IoT devices as the sub-headers of a RAR message in a NB-IoT RACH procedure may occur before a payload portion (e.g., a MAC PDU). For example, a MAC PDU for a RAR message may include a MAC header that includes all of the sub-headers for the RAR message that occurs before a MAC payload that indicate the MAC RARs within sub-payloads. In some cases, the RAR message for NB IoT UEs 115 (e.g., the UE 115-a) may include one or more bits within a set of octets. For example, the RAR message may include one or more reserved bits, one or more bits indicating a timing advance command, one or more bits indicating an uplink grant, one or more bits indicating a temporary C-RNTI, or any combination thereof. In some cases, a first reserved bit may be set to a value of 0. In some other cases, for a bandwidth reduced low complexity UE 115 or a UE 115 in enhanced coverage, the first reserved bit may be set to a value of 1 to indicate that the UL grant indicated via the RAR message is for EDT. Further, in a Msg4 for NB-IoT UEs 115, the message may include a MAC header that indicates one or more sub-headers followed by a MAC payload that includes one or more MAC-control elements (MAC-CEs) that correspond to the one or more sub-headers, one or more MAC service data units (SDUs) that correspond to the one or more MAC-CEs, the one or more sub-headers, or both, a set of padding data, or any combination thereof.

In some examples, limiting NB-IoT UEs 115 to a four-step RACH procedure may reduce the performance capabilities, efficiency, and reliability of NB-IoT UEs 115 and a corresponding wireless communication system. For example, four-step RACH procedures may consume a relatively large quantity of power resources and NB-IoT UEs 115 may have limited power capabilities. Moreover, the signaling overhead associated with four-step RACH procedures may result in an increase in delay for the RACH procedure which can increase the latency of communication between the UE 115-a and the network entity 105-a within a wireless communications system. Therefore, in accordance with the techniques of the present disclosure, a two-step RACH procedure may be implemented for NB-IoT communications by utilizing the structure of the Msg3 in the four-step RACH procedure for NB-IoT communications and the configuration of the MsgB in the two-step RACH procedure for non-NB-IoT communications. Within the two-step RACH procedure for NB-IoT communications, the UE 115-a, which may be an NB-IoT UE 115, may transmit, to the network entity 105-a via the communication link 205 and via at least one transmission occasion in a group of transmission occasions, at least one contention-based random access message 215 using a resource from a set of resources of the at least one transmission occasion. In some cases, the at least one contention-based random access message 215 may indicate both a data signal transmission, a connection establishment request, or both. That is, the at least one contention-based random access message 215 may be used both for a RACH procedure and for EDT. For example, the at least one contention-based random access message 215 may include both an EDT from the UE 115-a to the network entity 105-a and a request to establish a connection with the network entity 105-a. Therefore, the techniques of the present disclosure may reduce the signaling overhead of both the RACH procedure and the EDT procedure by enabling the UE 115-a to both indicate data of an EDT and the connection establishment request via the at least one contention-based random access message 215.

In response to transmitting the at least one contention-based random access message 215, the UE 115-a may receive, from the network entity 105-a and via the communication link 210, a response message 220 (e.g., at least one response message) that corresponds to one or more UEs 115 that include the UE 115. In some examples, the response message 220 may be a MAC PDU that includes a header 225 (e.g., a MAC header) and a payload 230 that includes zero or more payload indications (e.g., MAC payloads). Further, the header 225 may include one or more sub-headers 235 (e.g., a sub-header 235-a, a sub-header 235-b, a sub-header 235-c, and a sub-header 235-d) that are indicated consecutively and prior to the payload 230 of the response message 220. Moreover, the one or more sub-headers 235 may include one or more bits indicative of a sub-header type. For example, the one or more bits of a respective sub-header 235 may indicate a type of sub-header that indicates a sub-payload 240 (e.g., a sub-payload 240-a, a sub-payload 240-b, and a sub-payload 240-c) that the respective sub-header 235 corresponds to.

In some examples, each sub-header 235 of the one or more sub-headers 235 may include a first bit indicating an extension field, E. The extension field may be a flag that indicates if one or more additional sub-headers 235 are present in the header 225 (e.g., the MAC header) or not. In some cases, if the E field is set to “1”, the E field may indicate a presence of one or more additional sub-headers 235 following a respective sub-header. Thus, if the E field is set to “0,” the E field may indicate that the payload 230 starts at the next byte where the payload 230 can indicate either a MAC SDU, a MAC-CE, padding, or any combination thereof, via a respective sub-payload 240.

A respective sub-header 235 may also include one or more bits that indicate a T1 field, a T2 field, an S field, or any combination thereof. The T1 field may indicate a flag indicating whether a respective sub-header 235 (e.g., a MAC sub-header) indicates an identifier of the UE 115-a that corresponds to the at least one contention-based random access message 215 or indicates the T2 field. In some cases, if the T1 field is set to a corresponding value of 1, the T1 field may indicate a presence of the identifier of the UE 115-a that corresponds to the at least one contention-based random access message 215. In some other cases, if T1 field is set a corresponding value of 0, the T1 field may indicate the presence of the T2 field in the respective sub-header. The T2 field may indicate a flag indicating whether a respective sub-header 235 (e.g., a MAC sub-header) contains a Backoff Indicator (BI) within a BI field or a MAC SDU indicator(S). In some cases, if the T2 field is set to a corresponding value of 0, the T2 field may indicate the presence of a Backoff Indicator field in the respective sub-header 235. In some other cases, if the T2 field is set to a corresponding value of 1, the T2 field may indicate the presence of the S field in the respective sub-header 235. The S field may indicate whether a respective sub-header 235 (e.g., a MAC sub-header) that corresponds to a MAC SDU follows the present sub-header. In some cases, if the S field is set to a corresponding value of 1, the S field may indicate a presence of a respective sub-header 235 that corresponds to a MAC SDU following the sub-header 235 with the S field. In some other cases, if the S field is set to a corresponding value of 0, the S field may indicate absence of a respective sub-header 235 that corresponds to a MAC SDU following the sub-header 235 with the S field. In some examples, one or more sub-headers 235 for a MAC SDU may immediately follow a respective sub-header 235 with a contention-based random access message success sub-header type. In some other examples, the one or more sub-headers 235 for respective MAC SDUs may occur at the end of the header 225 of the response message 220.

In some examples, the one or more bits of the sub-header 235-a may indicate that the sub-header 235 type of the sub-header 235-a is a backoff indicator sub-header type (e.g., a MAC sub-header that indicates a BI field). For example, the sub-header 235-a may include one or more bits indicating the T1 field with a corresponding value of 0 to indicate a presence of the T2 field, the T2 field with a corresponding value of 0 to indicate a presence of the BI field, and the BI field to indicate a backoff indicator. In some examples, the backoff indicator may indicate a duration for the UE 115-a to retry a transmission of the at least one contention-based random access message 215. For example, the backoff indicator can indicate a duration of 5 seconds indicating that the UE 115-a should retry the transmission of the at least one contention-based random access message 215 after 5 seconds. Further, since the sub-header 235-a corresponds to a backoff indicator sub-header type, the sub-header 235-a may lack a corresponding sub-payload 240 as the backoff indicator is indicated directly within the sub-header 235-a. Additionally, or alternatively, if there are one or more sub-headers 235 that follow the sub-header 235-a, the E field within the sub-header 235-a may be set to a corresponding value of 1, otherwise the E field may be set to a corresponding value of 0 to indicate that the sub-header 235-a is the last sub-header 235 within header 225 of the response message 220.

In another example, the one or more bits of the sub-header 235-b may indicate that the sub-header 235 type of the sub-header 235-b is a contention-based random access message failure sub-header type. Further, the one or more bits of the sub-header 235-b may indicate that the sub-header 235-b corresponds to the sub-payload 240-a within the payload 230 of the response message 220 where the sub-payload 240-a includes a retransmission request for the at least one contention-based random access message 215. In some examples, the one or more bits of the sub-header 235-b may include an indication of a first field (e.g., the E field) with a corresponding value that is indicative of a presence of one or more additional sub-headers within the header 225 of the response message 220, an indication of a second field (e.g., the T1 field) with a corresponding value that is indicative of a presence of an identifier of the UE 115-a that corresponds to the at least one contention-based random access message 215, an indication of the identifier of the UE 115-a, or any combination thereof.

In some examples, since the UE 115-a may refrain from indicating a preamble within the at least one contention-based random access message 215, the network entity 105-a may generate an identifier for the UE 115-a such that the UE 115-a can determine that the sub-header 235-b and the sub-payload 240-a is associated with the UE 115-a. In some cases, the identifier of the UE 115-a may be based on the resource from the set of resources of the at least one transmission occasion that the UE 115-a used to transmit the at least one contention-based random access message 215 (e.g., a frequency resource such as a subcarrier index), an orthogonal cover code (OCC) resource, and the at least one transmission occasion that the UE 115-a used to transmit the at least one contention-based random access message 215 (e.g., an occasion within a diversity slotted ALOHA (DSA) window). A UE 115 may use an occasion of a DSA window based on being configured with a DSA scheme. In some examples, a DSA scheme may be an example of a random access scheme where a UE 115 (e.g., the UE 115-a) is configured with multiple (e.g., two or more) transmission occasions within a transmission occasion group that the UE 115-a can choose or select from for transmission of a random access message (e.g., the at least one contention-based random access message 215). Further, each transmission occasion may include a set of resources shared between a set of UEs 115 and the UEs 115 may randomly select a resource within the transmission occasion for transmission of the random access message. Thus, as long as at least one resource and transmission pair in which the UE 115-a transmits in does not collide with another UE 115 transmission, the UE 115-a may have a successful random access procedure.

In some cases, the UE 115-a may be capable of reusing the configuration of a sub-header used in a two-step RACH procedure for non-NB-IoT devices that indicates a contention-based random access message failure sub-header type for the configuration of the sub-header 235-b. In some examples, the configuration for the corresponding sub-header used in a two-step RACH procedure for non-NB-IoT devices may have a quantity of bits that is shorter than a quantity of bits of the identifier of the UE 115-a. In such examples, the UE 115-a may use a different configuration for the sub-header 235-b. In some cases, the sub-header 235-b may utilize a 2 byte sub-header for the sub-header 235-b such that all the bits of the identifier of the UE 115-a can fit. In some other cases, the network entity 105-a may include a first portion of the identifier of the UE 115-a within the sub-header 235-b and a second portion of the identifier of the UE 115-a (e.g., a remining portion) within the sub-payload 240-a that the sub-header 235-b corresponds with.

Within the sub-payload 240-a that corresponds to the sub-header 235-b and includes the retransmission request for the at least one contention-based random access message 215, the sub-payload 240-a may include a first bit to indicate whether the retransmission request indicates a retransmission grant or a fallback indication, and one or more bits to indicated a timing advance command, an uplink grant (e.g., indicated via 15 bits), a temporary C-RNTI (e.g., indicated via 16 bits), or any combination thereof. In some cases, in an uplink grant that is indicated via a RAR, a redundancy version may be assumed to be 0 and a quantity of resource units (RU) may be based on a MCS and an EDT-transport block size (TBS). Further, in an uplink grant indicated via a DCI, a redundancy version may be signaled, and a quantity of RUs may be signaled.

In some examples, for the uplink grant indicated via the sub-payload 240-a, for retransmission of EDT (e.g., the retransmission request indicating a retransmission grant), the network entity 105-a may use same the format for the uplink grant from RAR and may indicate a redundancy version via the uplink grant based on the retransmission request indicating the retransmission grant. Further, the network entity 105-a may be capable of refraining from indicating an uplink subcarrier spacing as the UE 115-a may be expected to use the same subcarrier spacing used for transmitting the at least one contention-based random access message 215. Moreover, the network entity 105-a may include the redundancy version within the uplink grant to enable the network entity 105-a to perform HARQ combining.

In some other examples, for the uplink grant indicated via the sub-payload 240-a, the retransmission request may indicate a fallback indication that indicates for the UE 115-a to switch to a different random access procedure type (e.g., from the two-step RACH procedure to a four-step RACH procedure) for a retransmission of the at least one contention-based random access message 215. In such examples, where the uplink grant is for a non-EDT transmission, the network entity 105-a may refrain from indicating the redundancy version within the uplink grant and may indicate an uplink subcarrier spacing. Therefore, the UE 115-a may receive, via the uplink grant indicated in the sub-payload 240-a, an indication of an uplink subcarrier spacing that is based on the retransmission request indicating the fallback indication for the retransmission of the at least one contention-based random access message 215.

In some examples, the network entity 105-a may also include the sub-header 235-c within the header 225 of the response message 220. In some cases, the one or more bits of the sub-header 235-c may indicate that the sub-header 235 type of the sub-header 235-b is a contention-based random access message success sub-header type. Further, the one or more bits of the sub-header 235-c may indicate that the sub-header 235-c corresponds to the sub-payload 240-b within the payload 230 of the response message 220 where the sub-payload 240-b includes an indication of a successful reception of the at least one contention-based random access message 215. In some examples, the one or more bits of the sub-header 235-c may include an indication of a first field (e.g., the E field) with a corresponding value that is indicative of a presence of one or more additional sub-headers within the header 225 of the response message 220, an indication of a second field (e.g., the T1 field) with a corresponding value that is indicative of a presence of a third field (e.g., the T2 field), an indication of the third field with a corresponding value that is indicative of a presence of a SDU indicator, an indication of a fourth field (e.g., the S field) with a corresponding value that is indicative of a presence of a SDU sub-header subsequent to the sub-header 235-c, or any combination thereof.

In some cases, for non-NB-IoT two-step RACH procedures, a UE 115 may read a sub-header of a response message that corresponds to a successful random access message payload and the UE 115 may read the entire payload portion to find a UE 115 contention resolution ID that matches the UE 115. In accordance with the techniques of the present disclosure, in the two-step RACH procedure for NB-IoT UEs 115 (e.g., the UE 115-a) at least a portion of a transmission ID (e.g., the identifier of the UE 115-a indicated at least in part within the sub-header 235-b) may be included in the sub-header 235-c. Therefore, the UE 115-a may be capable of skipping reading sub-payloads 240 that correspond to sub-headers where the part of the transmission ID refrains from matching the ID associated with the at least one contention-based random access message 215.

Additionally, or alternatively, the fourth field may be indicative of a bit that indicates an S flag indicating if a MAC SDU associated with the at least one contention-based random access message 215 that is successfully received by the network entity 105-a follows. If there is a lack of a MAC SDU in the response message 220, the UE 115-a may use a C-RNTI assigned earlier to monitor for an RRC message from the network entity 105-a in the future. Additionally, or alternatively, the sub-header 235-c, the sub-payload 240-b, or both may include an indication of whether the UE 115-a should switch to a different power saving state. For example, the sub-header 235-c, the sub-payload 240-b, or both may include a flag I to indicate for the UE 115-a to switch to an idle state based on the successful reception of the at least one contention-based random access message 215. In such cases, the network entity 105-a may refrain from providing a MAC SDU (e.g., a sub-payload 240 that indicates a level 2 (L2) acknowledgment (ACK) indication) to the UE 115-a. In some examples, the network entity 105-a may also determine to skip the HARQ feedback from the UE 115-a when the UE 115-a is being moved to the idle state. For example, the network entity 105-a may include, within the sub-header 235-c, the sub-payload 240-b, or both, a flag H that indicates if a HARQ feedback indication is enabled. In some cases, by disabling the HARQ feedback configuration, the UE 115-a may thus be capable of moving to the idle state relatively sooner to increase the power savings associated with moving to the idle state.

Therefore, in some examples, in accordance with the techniques of the present disclosure, the sub-payload 240-b that indicates a successful reception of the at least one contention-based random access message 215 may have one or more different formats. For example, in some cases, the sub-payload 240-b may include one or more bits to indicate a UE contention resolution identity (e.g., indicated via 48 bits), a timing advance command, a C-RNTI (e.g., indicated via 16 its), a HARQ feedback indicator, or any combination thereof. In some cases, the HARQ feedback indicator may be four bits. However, based on a quantity of UEs 115 that the response message 220 is multicast to (e.g., the quantity of UEs 115 that the response message 220 includes multiplexed information for), such quantity of bits may be insufficient. Thus, in accordance with the techniques of the present disclosure, the network entity 105-a may dynamically allocate the quantity of bits for the HARQ feedback indicator based on a quantity of UEs 115 that the response message 220 corresponds to. Thus, the network entity 105-a may be capable of flexibly allocating resources to the UEs 115 for HARQ transmissions.

In another cases, when the UE 115-a is moved to the idle state, the network entity 105-a may indicate, via the sub-payload 240-b, a UE contention resolution identity for the UE 115-a to use for subsequent communications and may refrain from indicating a timing advance command, a C-RNTI, a HARQ feedback indicator, or any combination thereof. In some other cases, the sub-payload 240-b may include the UE contention resolution identity for the UE 115-a, a feedback configuration indicator, or both and may refrain from indicating a timing advance, a network identifier, or both. Therefore, the network entity 105-a may be capable of reducing the information transmitted via the sub-payload 240-b when the UE 115-a is moving to the idle state, thus reducing the overall signaling overhead and processing power consumed at the UE 115-a. Additionally, or alternatively, if absent from the sub-payload 240-b, the UE 115-a may be capable of deriving or identifying a temporary network identifier (e.g., a temporary C-RNTI) for a feedback transmission in accordance with the feedback configuration (e.g., the HARQ feedback indicator) based on a frame number corresponding to a transmission of the at least one contention-based random access message 215, a frame number of the response message 220, an index of a respective sub-header within the response message 220 the feedback configuration, or any combination thereof.

In some examples, a respective sub-payload 240 (e.g., the sub-payload 240-b) may include a timing advance command that may indicate a timing advance modification value rather than a full timing advance value. For example, in a RAR, a timing advance command may be used to set a value of a timing advance via an index using a first set of bits (e.g., 11 bits) and if set, the timing advance can be modified by incrementing or decrementing the timing advance value by a respective value indicated via a second set of bits (e.g., 6 bits). In some examples, UEs 115 (e.g., the UE 115-a) performing the two-step RACH procedure may already have relatively sufficient timing synchronization with the network entity 105-a when transmitting the at least one contention-based random access message 215. For example, the UE 115-a may acquire the location of the network entity 105-a (e.g., utilizing GNSS) and can compute or determine a timing advance value based on the satellite ephemeris and a common timing advance. Thus, subsequent timing advance adjustments may be relatively minor. Therefore, in accordance with the techniques of the present disclosure, the network entity 105-a may be capable of utilizing a relatively small quantity of bits for a timing advance command within the response message 220. As described herein, the network entity 105-a may indicate a RNTI for the UE 115-a to utilize within the sub-payload 240-b. In four-step random access, an RNTI (e.g., a RA-RNTI) may be calculated via Equation 1 below and in two-step random access, a MsgB-RNTI may be calculated via Equation 2 below. Within Equation 1 and Equation 2, s_id may represent an index of the first OFDM symbol of the PRACH occasion (0≤s_id<14), t_id may represent an index of a first slot of the PRACH occasion in a system frame (0≤t_id<80), where the subcarrier spacing may be used to determine t_id based on the value of μ (e.g., for μ={0, 1, 2, 3}, and for μ={5, 6}). Further, t_id may be an index of the 120 kHz slot in a system frame that contains the PRACH occasion (0≤t_id<80), f_id may represent an index of the PRACH occasion in the frequency domain (0≤f_id<8), and ul_carrier_id may represent the uplink carrier used transmitting a random access preamble (0 for non-uplink carrier, and 1 for supplementary uplink carrier). The RNTI for MsgB may be offset by a value of 14*80*8*2 to ensure that a separation between the two-step RACH RNTIs and the four-step RACH RNTIs.

$$RA RNTI = 1 + {s}_{id} + 14 * {t}_{id} + 14 * 80 * {f}_{id} + 14 * 80 * 8 * {UL}_{{carrier}_{id}} \qquad ( 1 )$$

$$MsgB RNTI = 1 + {s}_{id} + 14 * {t}_{id} + 14 * 80 * {f}_{id} + 14 * 80 * 8 * {UL}_{{carrier}_{id}} + 14 * 80 * 8 * 2 \qquad ( 2 )$$

In such cases, a UE 115 may utilize the MsgB-RNTI to monitor for a PDCCH for MsgB. For a MsgA transmission, a scrambling generator may be initialized as indicated via Equation 3 below where n_{RAPID} is an index of the random-access preamble transmitted for MsgA and where n_{RNTI} equals the RA-RNTI for MsgA.

$${c}_{int} = \{ \begin{matrix}{n}_{RNTI} \cdot {2}^{16} + {n}_{RAPID} \cdot {2}^{10} + {n}_{ID} & for msgA on PUSCH \\ {n}_{RNTI} \cdot {2}^{15} + q \cdot {2}^{14} + {n}_{ID} & otherwise\end{matrix} \qquad ( 3 )$$

For NB-IoT UEs 115 (e.g., the UE 115-a), the RA-RNTI associated with the PRACH that the random access preamble is transmitted within may be calculated via Equation 4 below. In Equation 4 below, SFN_id may represent an index of a first radio frame of the specified PRACH and carrier_id may represent an index of an uplink carrier associated with the specified PRACH. The carrier_id of the anchor carrier may be set to a value of 0. Additionally, or alternatively, the network entity 105-a may utilize a minimum PRACH periodicity of 40 milliseconds (ms) and SFN/4 to prevent RA-RNTI collisions until the SFN loops back.

$$RA RNTI = 1 + floor ( \frac{{SFN}_{id}}{4} ) + 256 * {carrier}_{id} \qquad ( 4 )$$

For the two-step RACH procedure for NB-IoT UEs 115 described in accordance with the techniques of the present disclosure herein, the UE 115-a may have to monitor for a RNTI that is common for all PUSCH resources within a DSA group. Thus, similar to the MsgB-RNTI, the network entity 105-a may add a value of 256 multiplied by a maximum quantity of carriers (e.g., 256*MaxNumOfCarriers). Therefore, the network entity 105-a may calculate the RNTI using Equation 5 below where SFN_id may be an index of a first radio frame of the first PUSCH resource in the group and carrier_id may be an index of the uplink carrier associated with a specified CB-Msg4 resource (e.g., a resource for the response message 220). The carrier_id of the anchor carrier may be set to a value of 0. Moreover, the network entity 105-a may select a value of M to be larger than 4 as a periodicity of a group may be larger than 40 ms.

$$CB Msg 4 RNTI = 1 + floor ( \frac{{SFN}_{id}}{M} ) + ( \frac{1024}{M} ) * {carrier}_{id} + 256 * MaxNumofCarriers \qquad ( 5 )$$

In some examples, a group duration may be relatively long, and a relatively long contention resolution timer can be used that exceeds a threshold value (e.g., 10.24 seconds). In such cases, as indicated via Equation 6 below, the RNTI can be determined based on a hyper-SFN (H-SFN) term to avoid RNTI collisions.

$$CB Msg 4 RNTI = 1 + floor ( \frac{{SFN}_{id}}{M} ) + ( \frac{1024}{M} ) * {carrier}_{id} + ( \frac{1024}{M} ) * MaxNumofCarriers * mod ( H - SFN , N ) ) + 256 * MaxNumofCarriers \qquad ( 5 )$$

Additionally, or alternatively, the UE 115-a may use an RNTI for scrambling the at least one contention-based random access message 215 that is different or the same as an RNTI that the UE 115-a may use for monitoring for the response message 220. Further, the RNTI used for scrambling different replicas (e.g., repetitions or retransmissions of the at least one contention-based random access message 215) may be different and can be based on an occasion, frequency resource, and OCC.

In some examples, as described herein, contention-based EDT may be utilized such that the UE 115-a can transmit the at least one contention-based random access message 215 without a separate Msg1 and Msg2. Further, the Msg4 or response message 220 may be a multicast message that targets multiple UEs 115. In some cases, the format for the response message 220 may be different for L2 ACK, a success response, a response with an RRC message, and a retransmission grant.

For an L2 ACK, the network entity 105-a may include a list of MAC PDUs within the response message 220 that indicates the contention resolution identifiers of the multiple UEs 115 associated with the response message 220 and refrains from indicating any additional information. Further, based on reception of the response message 220, if UE 115-a finds a contention resolution identifier that matches, the UE 115-a may move to an RRC idle mode. Otherwise, the UE 115-a may keep monitoring the response message 220. In some cases, such format may be applicable for when the Msg4 or the second message in the two-step RACH procedure for NB-IoT UEs 115 described herein is addressed to a contention-based RNTI. Further, for L2 ACK, an SDU of the response message 220 may indicate a respective contention resolution identifier and a resource for a Msg4 ACK. In some cases, the SDU may also include a timing advance for an uplink transmission. Further, an RNTI for HARQ feedback scrambling may be derived from the resource or same CB-Msg3 EDT RNTI can be used. In some cases, the network entity 105-a can also include a temporary C-RNTI for HARQ ACK feedback scrambling. Additionally, or alternatively, if the timing advance is absent, the UE 115-a may use a same procedure for a timing advance as done for the Msg3 transmission (e.g., the transmission of the at least one contention-based random access message 215). Moreover, in some cases, the network entity 105-a may include the TA command in the response message 220 (e.g., via octet 8/9 in the response message 220). Thus, for L2 ACK without RRC, the one or more bits of a sub-header 235, a sub-payload 240, or both may be E=0, N=1 (for a first UE 115), T=0, L1/L2=0, H=1 (e.g., indicating that HARQ feedback is enabled). Further, a value for the one or more bits may be represented via Table 1 below.

TABLE 1

| | |
|---|---|
| E = 0 | Sub-header type 1 |
| E = 1 | Sub-header type 2 |
| N = 1 | Next SDU, next sub-header to follow |
| N = 0 | Last SDU, padding to follow |
| T = 0 | Header format 1 (L2 ACK) |
| T = 1 | Header format 2 (success response) |
| L1 = 0 | No length field for RRC data |
| L1 = 1 | Length field present for RRC data |
| L2 = 0 | No length field (no user data) |
| L2 = 1 | Next length field present for user |
| | downlink data (same logical channel |
| | identifier) |
| H = 0 | HARQ feedback disabled (no HARQ |
| | resource) |
| H = 1 | HARQ feedback enabled (HARQ |
| | resource and TA command) |

In some examples, the response message 220 (e.g., the multicast Msg4) may also include a list of MAC PDUs including contention resolution identifiers, HARQ ACK resources, RRC release messages for the multiple UEs 115, or any combination thereof. In such examples, for the L2 ACK, the response message 220 may be expected to include a contention resolution identifier and resources for a Msg4 ACK. Additionally, or alternatively, the network entity 105-a may also include a timing advance command and a temporary C-RNTI. Further, for L2 ACK with the RRC release message, the one or more bits may be indicated as follows: E=0, N=1 (for first UE), T=0, L1=1, L2=0, H=1. In such cases, L1 having a value of 1 may indicate that an L fields is present in the MAC sub-header and an RRC message may be included at the end of a MAC SDU.

For a success response message (e.g., a multicast Msg4 or the response message 220), the network entity 105-a may include a list of the MAC PDUs including a success response of the multiple UEs 115. Further, the network entity 105-a may include a contention resolution identifier, a resource for a Msg4 ACK, a timing advance command, a C-RNTI, or any combination thereof within the success response message. In some cases, a value of T=1 may refrain from indicating for a UE 115 to go to an idle mode. In some cases, such indication may be useful for cases where a response refrains from including any RRC message. Thus, for a success response without RRC, the one or more bits of the message may be indicated as, E=0, N=1 (for first UE), T=0, L1=1, L2=0, H=1, where T=1 may indicate a success response SDU, and that the UE 115 should refrain from going to RRC idle.

Further, for a success response with an RRC message, the network entity 105-a may include a list of MAC PDUs including the success responses of multiple UEs 115 within the response message 220 (e.g., the multicast Msg4). Additionally, or alternatively, such indication may be included in an RRC setup message. In some cases, for a success response, a value of 1 for the T field may refrain from indicating for the UE 115 to go to an idle mode. Rather, for a success response message with the following bits, E=0, N=1 (for first UE), T=0, L1=1, L2=0, and H=1, T=1 may indicate a success response SDU and L1=1 may indicate that an L field is present in the MAC sub-header and that an RRC message is included at the end of the MAC SDU.

In some examples, the response message 220 (e.g., the multicast Msg4) may also indicate a single replica retransmission grant. In such examples, a sub-header 235 (e.g., a MAC sub-header) may include a UE 115 transmission resource indicator and a corresponding sub-payload 240 (e.g., a MAC SDU) may include an uplink grant, a timing advance command, or both. In some cases, the sub-header 235-d may include one or more bits indicating that the sub-header 235-d corresponds to a MAC SDU sub-header type and the sub-payload 240-c that corresponds to the sub-header 235-d may be indicative of a MAC SDU. To indicate that the sub-header 235-d corresponds to a MAC SDU, the one or more bits of the sub-header 235-d may include a first field (e.g., an F field that indicates a format, a second field (e.g., an E field) that indicates whether there are one or more additional sub-headers 235 following the sub-header 235-d, a third field indicating a logical channel identifier, and a fourth field (e.g., an L field) indicating a length of the corresponding MAC SDU (e.g., a length of the sub-payload 240-c).

In some cases, for a retransmission grant, a sub-header 235 may include one or more bits for an E field (e.g., E=1) and an N field (e.g., N=1 for a first UE 115). When E=1, the sub-header 235 may have a length of 2 bytes that includes a set of bits (e.g., 9 bits) for a transmission resource indicator. For example, with a 9 bit transmission resource indicator, for contention-based EDT with a single replica, the 6 least significant bits of the indicator may be applicable, and the 3 most significant bits of the indicator may be zeros. For contention-based EDT with multiple replicas, the 8 least significant bits of the indicator may be applicable, and the 2 most significant bits of the indicator may be zeros. Moreover, for contention-based EDT with OCC, all 9 bits may be used for the transmission resource indicator.

Additionally, or alternatively, the retransmission grant may indicate for a UE 115 to update a Msg3 buffer or fall back to EDT or a four-step RACH procedure. Such indications may be dependent on the content of an uplink grant field in a MAC SDU (e.g., the sub-payload 240-c). For example, if an uplink grant field indicates the uplink grant with a relatively small TBS capable of fitting an RRC connection request message, then the UE 115 may update the Msg3 and send the RRC connection message without the uplink data indicated via the at least one contention-based random access message 215 (e.g., EDT fallback). In another example, if the uplink grant indicates that no TBS size is valid, the UE 115 may fall back to the four-step RACH procedure and transmit a random access preamble via a Msg1 as described herein.

Therefore, in accordance with the described techniques, NB-IoT UEs 115 (e.g., the UE 115-a) may be capable of implementing two-step RACH procedure. By implementing the two-step RACH procedures, the UE 115-a and the network entity 105-a may have increased power savings due to the reduction in signaling overhead and correspond processing reduction associated with the signaling overhead reduction (e.g., relatively fewer messages are generates, transmitted, received, and decoded within the two-step RACH procedure). Further descriptions of the techniques of the present disclosure that improve the communication between the UE 115-a and the network entity 105-a may be described elsewhere herein, such as with reference to FIG. 3.

FIG. 3 shows an example of a process flow 300 that supports a contention-based random access response message configuration. In some examples, the process flow 300 may implement or be implemented by the wireless communications system 100, the signaling diagram 200, or both. For example, the process flow 300 may include UE 115-b and a network entity 105-b, which may be examples of devices described herein with reference to FIGS. 1 and 2. Further, the appendix included herein may be incorporated entirely within the techniques described herein within the description of the process flow 300.

In the following description of the process flow 300, the operations between the UE 115-b and the network entity 105-b may be performed in different orders or at different times. Some operations may also be left out of the process flow 300, or other operations may be added. Although the UE 115-b and the network entity 105-b are shown performing the operations of the process flow 300, some aspects of some operations may also be performed by one or more other wireless devices.

At 305, the UE 115-b may transmit, to the network entity 105-b via at least one transmission occasion in a group of transmission occasions, at least one contention-based random access message using a resource from a set of resources of the at least one transmission occasion. In some examples, the at least one contention-based random access message may indicate a data signal transmission, a connection establishment request, or both. Further, the UE 115-b may be an example of a NB-IoT device.

At 310, the UE 115-b may receive, from the network entity 105-b and in response to transmitting the at least one contention-based random access message, at least one response message that corresponds to one or more UEs 115 that includes the UE 115-b. The at least one response message may include one or more sub-headers that are indicated consecutively and prior to a payload portion of the at least one response message and the one or more sub-headers may include one or more bits indicative of a sub-header type. In some examples, the at least one response message may corresponds to the one or more UEs 115 based on the at least one response message being a multicast message. Further, in some cases, the UE 115-b may use a first radio network identifier to transmit the at least one contention-based random access message that is a same radio network identifier or a different radio network identifier as a second radio network identifier that the UE 115-b uses to monitor for the at least one response message.

In some examples, the UE 115-b may receive, via the one or more sub-headers indicated via the at least one response message, a first sub-header that includes one or more bits indicating that the sub-header type of the first sub-header is a contention-based random access message failure sub-header type. In some cases, the one or more bits of the first sub-header may indicate that the first sub-header corresponds with a first sub-payload within the payload portion that includes a retransmission request for the at least one contention-based random access message transmitted by the UE 115-b. In some examples, the one or more bits of the first sub-header may include an indication of a first field with a corresponding value that is indicative of a presence of one or more additional sub-headers within the at least one response message, an indication of a second field with a corresponding value that is indicative of a presence of an identifier of the UE 115-b that corresponds to the at least one contention-based random access message, an indication of the identifier of the UE 115-b, or any combination thereof. Further, the identifier of the UE 115-b may be based on the resource from the set of resources of the at least one transmission occasion that the UE 115-b used to transmit the at least one contention-based random access message, an OCC resource, and the at least one transmission occasion that the UE 115-b used to transmit the at least one contention-based random access message. In some cases, a first portion of the identifier of the UE 115-b may be indicated via the first sub-header for the first sub-payload and a second portion of the identifier of the UE 115-b may be indicated via the first sub-payload.

In some examples, the UE 115-b may receive, via the first sub-payload within the payload portion, an indication of whether the retransmission request indicates a retransmission grant or an fallback indication, a timing advance command, an uplink grant, a temporary network identifier, or any combination thereof. In some cases, the UE 115-b may receive, via the uplink grant indicated in the first sub-payload, an indication of a redundancy version based on the retransmission request indicating the retransmission grant. Further, the fallback indication may include an indication for the UE 115-b to switch to a different random access procedure type for a retransmission of the at least one contention-based random access message. As such, the UE 115-b may receive, via the uplink grant indicated in the first sub-payload, an indication of an uplink subcarrier spacing based on the retransmission request indicating the fallback indication for the retransmission of the at least one contention-based random access message.

In another example, the UE 115-b may receive, via the one or more sub-headers indicated via the at least one response message, a first sub-header that includes one or more bits indicating that the sub-header type of the first sub-header is a backoff indicator sub-header type. In some cases, the one or more bits of the first sub-header may include an indication of a first field with a corresponding value that is indicative of a presence of one or more additional sub-headers within the at least one response message, an indication of a second field with a corresponding value that is indicative of a backoff indicator, or a combination thereof. Further, the backoff indicator may include an indication of a duration for the UE 115-b to retry the at least one contention-based random access message.

In some other examples, the UE 115-b may receive, via the one or more sub-headers indicated via the at least one response message, a first sub-header that includes one or more bits indicating that the sub-header type of the first sub-header is a contention-based random access message success sub-header type. In some cases, the one or more bits of the first sub-header may indicate that the first sub-header corresponds with a first sub-payload within the payload portion that includes an indication of a successful reception of the at least one contention-based random access message. In some examples, the one or more bits of the first sub-header may include an indication of a first field with a corresponding value that is indicative of a presence of one or more additional sub-headers within the at least one response message, an indication of a second field with a corresponding value that is indicative of a presence of a third field, an indication of the third field with a corresponding value that is indicative of a presence of a SDU indicator, an indication of a fourth field with a corresponding value that is indicative of a presence of a SDU sub-header subsequent to the first sub-header, or any combination thereof. Additionally, or alternatively, the first sub-header may also include at least a portion of an identifier of the UE 115-b associated with the at least one contention-based random access message.

Further, in some cases, the first sub-header, the first sub-payload, or both may include an indication whether the UE 115-b should switch to a different power saving state. In some examples, the first sub-payload may indicate a contention resolution identity for the UE 115-b and may refrain from indicating a timing advance command and a feedback configuration indicator based on the first sub-header, the first sub-payload, or both indicating for the UE 115-b to switch to a different power saving state. In some other examples, the first sub-payload may indicate a contention resolution identity for the UE 115-b, a feedback configuration indicator, or both, and refrain from indicating a timing advance, a network identifier, or both. In some other cases, the first sub-header, the first sub-payload, or both may include an indication of whether a feedback configuration is enabled within the first sub-payload. In such cases, a quantity of bits for the feedback configuration within the first sub-payload may be based on a quantity of UEs 115-b within the one or more UEs 115. Further, in some examples, the UE 115-b may derive or identify a temporary network identifier for a feedback transmission in accordance with the feedback configuration based on a frame number corresponding to a transmission of the at least one contention-based random access message, a frame number of at least one response message, an index of a respective sub-header within the at least one response message, the feedback configuration, or any combination thereof.

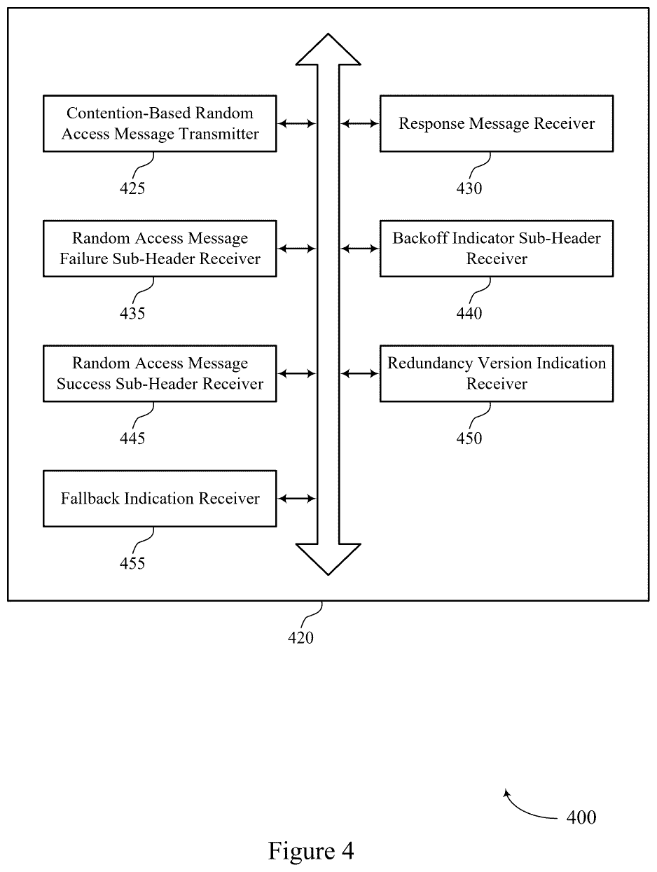

In some examples, a first sub-payload of the payload portion of the at least one response message may include a timing advance command that indicates a timing advance modification value. Moreover, in some cases, the UE 115-b may receive, via a first sub-payload of the payload portion of the at least one response message, an indication of a radio network identifier for subsequent communications, the radio network identifier being based on a maximum quantity of carriers, an SFN, an H-SFN, or any combination thereof. Further descriptions of the techniques of the present disclosure may be described elsewhere herein, such as with reference to FIGS. 4 through 7.

FIG. 4 shows an example 400 of a processing system 420 that supports a contention-based random access response message configuration. A processing system 420 may be an example of a processing system 140 (such as of a UE 115) and may include a contention-based random access message transmitter 425, a response message receiver 430, a random access message failure sub-header receiver 435, a backoff indicator sub-header receiver 440, a random access message success sub-header receiver 445, a redundancy version indication receiver 450, a fallback indication receiver 455, or any combination thereof. A processing system 420, or various component thereof, may be an example of means for performing (such as a means for causing a UE 115 to perform) various techniques described herein.

The contention-based random access message transmitter 425 may be configured to cause the UE 115 to transmit, via at least one transmission occasion in a group of transmission occasions, at least one contention-based random access message using a resource from a set of resources of the at least one transmission occasion. The response message receiver 430 may be configured to cause the UE 115 to receive, in response to transmitting the at least one contention-based random access message, at least one response message that corresponds to one or more UEs that include the UE, the at least one response message including one or more sub-headers that are indicated consecutively and prior to a payload portion of the at least one response message, where the one or more sub-headers include one or more bits indicative of a sub-header type.

In some examples, the random access message failure sub-header receiver 435 may be configured to cause the UE 115 to receive, via the one or more sub-headers indicated via the at least one response message, a first sub-header that includes one or more bits indicating that the sub-header type of the first sub-header is a contention-based random access message failure sub-header type, the one or more bits of the first sub-header indicating that the first sub-header corresponds with a first sub-payload within the payload portion that includes a retransmission request for the at least one contention-based random access message transmitted by the UE.

In some examples, the one or more bits of the first sub-header includes an indication of a first field with a corresponding value that is indicative of a presence of one or more additional sub-headers within the at least one response message, an indication of a second field with a corresponding value that is indicative of a presence of an identifier of the UE that corresponds to the at least one contention-based random access message, an indication of the identifier of the UE, or any combination thereof.

In some examples, the identifier of the UE is based on the resource from the set of resources of the at least one transmission occasion that the UE used to transmit the at least one contention-based random access message, an orthogonal cover code resource, and the at least one transmission occasion that the UE used to transmit the at least one contention-based random access message.

In some examples, a first portion of the identifier of the UE is indicated via the first sub-header for the first sub-payload and a second portion of the identifier of the UE is indicated via the first sub-payload.

In some examples, the response message receiver 430 may be configured to cause the UE 115 to receive, via the first sub-payload within the payload portion, an indication of whether the retransmission request indicates a retransmission grant or an fallback indication, a timing advance command, an uplink grant, a temporary network identifier, or any combination thereof.

In some examples, to support receiving the first sub-payload, the redundancy version indication receiver 450 may be configured to cause the UE 115 to receive, via the uplink grant indicated in the first sub-payload, an indication of a redundancy version based on the retransmission request indicating the retransmission grant.

In some examples, the fallback indication includes an indication for the UE to switch to a different random access procedure type for a retransmission of the at least one contention-based random access message.

In some examples, to support receiving the first sub-payload, the fallback indication receiver 455 may be configured to cause the UE 115 to receive, via the uplink grant indicated in the first sub-payload, an indication of an uplink subcarrier spacing based on the retransmission request indicating the fallback indication for the retransmission of the at least one contention-based random access message.

In some examples, the backoff indicator sub-header receiver 440 may be configured to cause the UE 115 to receive, via the one or more sub-headers indicated via the at least one response message, a first sub-header that includes one or more bits indicating that the sub-header type of the first sub-header is a backoff indicator sub-header type, the one or more bits of the first sub-header including an indication of a first field with a corresponding value that is indicative of a presence of one or more additional sub-headers within the at least one response message, an indication of a second field with a corresponding value that is indicative of a backoff indicator, or a combination thereof, where the backoff indicator includes an indication of a duration for the UE to retry the at least one contention-based random access message.

In some examples, the random access message success sub-header receiver 445 may be configured to cause the UE 115 to receive, via the one or more sub-headers indicated via the at least one response message, a first sub-header includes one or more bits indicating that the sub-header type of the first sub-header is a contention-based random access message success sub-header type, the one or more bits of the first sub-header indicating that the first sub-header corresponds with a first sub-payload within the payload portion that includes an indication of a successful reception of the at least one contention-based random access message.

In some examples, the one or more bits of the first sub-header includes an indication of a first field with a corresponding value that is indicative of a presence of one or more additional sub-headers within the at least one response message, an indication of a second field with a corresponding value that is indicative of a presence of a third field, an indication of the third field with a corresponding value that is indicative of a presence of a SDU indicator, an indication of a fourth field with a corresponding value that is indicative of a presence of a SDU sub-header subsequent to the first sub-header, or any combination thereof.

In some examples, the first sub-header includes at least a portion of an identifier of the UE associated with the at least one contention-based random access message.

In some examples, the first sub-header, the first sub-payload, or both includes an indication whether the UE should switch to a different power saving state.

In some examples, the first sub-payload indicates a contention resolution identity for the UE and refrains from indicating a timing advance command and a feedback configuration indicator based on the first sub-header, the first sub-payload, or both indicating for the UE to switch to a different power saving state.

In some examples, the first sub-payload indicates a contention resolution identity for the UE, a feedback configuration indicator, or both, and refrains from indicating a timing advance, a network identifier, or both.

In some examples, the first sub-header, the first sub-payload, or both includes an indication of whether a feedback configuration is enabled within the first sub-payload.

In some examples, a quantity of bits for the feedback configuration within the first sub-payload is based on a quantity of UEs within the one or more UEs.

In some examples, the UE identifies a temporary network identifier for a feedback transmission in accordance with the feedback configuration based on a frame number corresponding to a transmission of the at least one contention-based random access message, a frame number of at least one response message, an index of a respective sub-header within the at least one response message, the feedback configuration, or any combination thereof.

In some examples, a first sub-payload of the payload portion of the at least one response message includes a timing advance command that indicates a timing advance modification value.

In some examples, the response message receiver 430 may be configured to cause the UE 115 to receive, via a first sub-payload of the payload portion of the at least one response message, an indication of a radio network identifier for subsequent communications, the radio network identifier being based on a maximum quantity of carriers, an SFN, an H-SFN, or any combination thereof.

In some examples, the UE uses a first radio network identifier to transmit the at least one contention-based random access message that is a same radio network identifier or a different radio network identifier as a second radio network identifier that the UE uses to monitor for the at least one response message.

In some examples, the at least one contention-based random access message indicates a data signal transmission, a connection establishment request, or both.

In some examples, the at least one response message corresponds to the one or more UEs based on the at least one response message being a multicast message.

In some examples, the UE is a NB-IoT device.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for a contention-based random access response message configuration in a two-step random access procedure to provide improved communication reliability, reduced latency, improved user experience related to reduced processing, reduced power consumption, more efficient utilization of communication resources, improved coordination between devices, longer battery life, and improved utilization of processing capability.

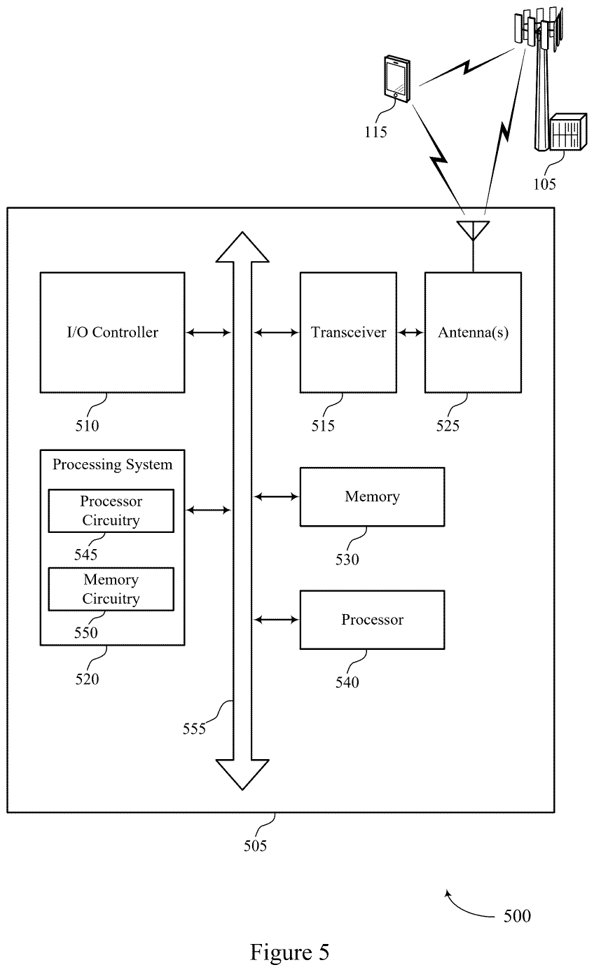

FIG. 5 shows an example of a system 500 including a device 505 that supports a contention-based random access response message configuration. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support contention-based random access response message configuration. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for a contention-based random access response message configuration in a two-step random access procedure to provide improved communication reliability, reduced latency, improved user experience related to reduced processing, reduced power consumption, more efficient utilization of communication resources, improved coordination between devices, longer battery life, and improved utilization of processing capability.

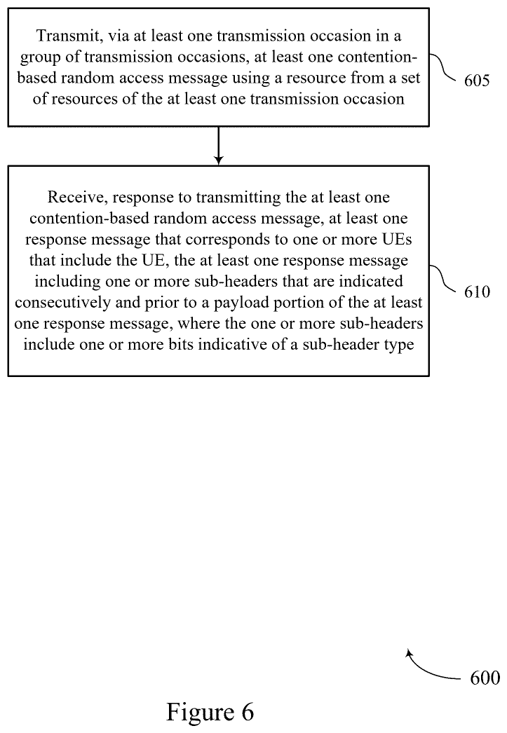

FIG. 6 shows an example of a method 600 that supports a contention-based random access response message configuration. Operations of the method 600 may be performed by a UE or its components (such as using a processing system configured to cause the UE 115 to perform one or more of the operations) as described herein.

At 605, the method may include transmitting, via at least one transmission occasion in a group of transmission occasions, at least one contention-based random access message using a resource from a set of resources of the at least one transmission occasion. In some examples, aspects of the operations of 605 may be performed by a contention-based random access message transmitter 425.

At 610, the method may include receiving, in response to transmitting the at least one contention-based random access message, at least one response message that corresponds to one or more UEs that include the UE, the at least one response message including one or more sub-headers that are indicated consecutively and prior to a payload portion of the at least one response message, where the one or more sub-headers include one or more bits indicative of a sub-header type. In some examples, aspects of the operations of 610 may be performed by a response message receiver 430.

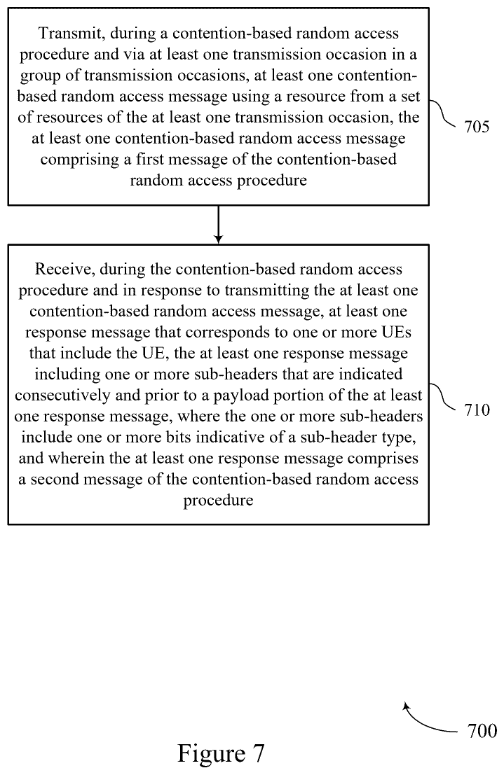

FIG. 7 shows an example of a method 700 that supports a contention-based random access response message configuration. Operations of the method 700 may be performed by a UE or its components (such as using a processing system configured to cause the UE 115 to perform one or more of the operations) as described herein.

At 705, the method may include transmitting, during a contention-based random access procedure and via at least one transmission occasion in a group of transmission occasions, at least one contention-based random access message using a resource from a set of resources of the at least one transmission occasion, the at least one contention-based random access message being a first message of the contention-based random access procedure. In some examples, aspects of the operations of 705 may be performed by a contention-based random access message transmitter 425.

At 710, the method may include receiving, during the contention-based random access procedure and in response to transmitting the at least one contention-based random access message, at least one response message that corresponds to one or more UEs that include the UE, the at least one response message including one or more sub-headers that are indicated consecutively and prior to a payload portion of the at least one response message, where the one or more sub-headers include one or more bits indicative of a sub-header type, and where the at least one response message is a second message of the contention-based random access procedure. In some examples, aspects of the operations of 710 may be performed by a response message receiver 430.

Implementation examples are described in the following numbered clauses:

Aspect 1: A method for wireless communications by a UE, comprising: transmitting, via at least one transmission occasion in a group of transmission occasions, at least one contention-based random access message using a resource from a set of resources of the at least one transmission occasion; and receiving, in response to transmitting the at least one contention-based random access message, at least one response message that corresponds to one or more UEs that comprise the UE, the at least one response message comprising one or more sub-headers that are indicated consecutively and prior to a payload portion of the at least one response message, wherein the one or more sub-headers include one or more bits indicative of a sub-header type.

Aspect 2: The method of aspect 1, further comprising: receiving, via the one or more sub-headers indicated via the at least one response message, a first sub-header that comprises one or more bits indicating that the sub-header type of the first sub-header is a contention-based random access message failure sub-header type, the one or more bits of the first sub-header indicating that the first sub-header corresponds with a first sub-payload within the payload portion that comprises a retransmission request for the at least one contention-based random access message transmitted by the UE.

Aspect 3: The method of aspect 2, wherein the one or more bits of the first sub-header comprises an indication of a first field with a corresponding value that is indicative of a presence of one or more additional sub-headers within the at least one response message, an indication of a second field with a corresponding value that is indicative of a presence of an identifier of the UE that corresponds to the at least one contention-based random access message, an indication of the identifier of the UE, or any combination thereof.

Aspect 4: The method of aspect 3, wherein the identifier of the UE is based at least in part on the resource from the set of resources of the at least one transmission occasion that the UE used to transmit the at least one contention-based random access message, an orthogonal cover code resource, and the at least one transmission occasion that the UE used to transmit the at least one contention-based random access message.

Aspect 5: The method of aspect 4, wherein a first portion of the identifier of the UE is indicated via the first sub-header for the first sub-payload and a second portion of the identifier of the UE is indicated via the first sub-payload.

Aspect 6: The method of any of aspects 3 through 5, further comprising: receiving, via the first sub-payload within the payload portion, an indication of whether the retransmission request indicates a retransmission grant or an fallback indication, a timing advance command, an uplink grant, a temporary network identifier, or any combination thereof.

Aspect 7: The method of aspect 6, wherein receiving the first sub-payload comprises: receiving, via the uplink grant indicated in the first sub-payload, an indication of a redundancy version based at least in part on the retransmission request indicating the retransmission grant.

Aspect 8: The method of any of aspects 6 through 7, wherein the fallback indication comprises an indication for the UE to switch to a different random access procedure type for a retransmission of the at least one contention-based random access message.

Aspect 9: The method of aspect 8, wherein receiving the first sub-payload comprises: receiving, via the uplink grant indicated in the first sub-payload, an indication of an uplink subcarrier spacing based at least in part on the retransmission request indicating the fallback indication for the retransmission of the at least one contention-based random access message.

Aspect 10: The method of any of aspects 1 through 9, further comprising: receiving, via the one or more sub-headers indicated via the at least one response message, a first sub-header that comprises one or more bits indicating that the sub-header type of the first sub-header is a backoff indicator sub-header type, the one or more bits of the first sub-header comprising an indication of a first field with a corresponding value that is indicative of a presence of one or more additional sub-headers within the at least one response message, an indication of a second field with a corresponding value that is indicative of a backoff indicator, or a combination thereof, wherein the backoff indicator comprises an indication of a duration for the UE to retry the at least one contention-based random access message.

Aspect 11: The method of any of aspects 1 through 10, further comprising: receiving, via the one or more sub-headers indicated via the at least one response message, a first sub-header comprises one or more bits indicating that the sub-header type of the first sub-header is a contention-based random access message success sub-header type, the one or more bits of the first sub-header indicating that the first sub-header corresponds with a first sub-payload within the payload portion that comprises an indication of a successful reception of the at least one contention-based random access message.

Aspect 12: The method of aspect 11, wherein the one or more bits of the first sub-header comprise an indication of a first field with a corresponding value that is indicative of a presence of one or more additional sub-headers within the at least one response message, an indication of a second field with a corresponding value that is indicative of a presence of a third field, an indication of the third field with a corresponding value that is indicative of a presence of a SDU indicator, an indication of a fourth field with a corresponding value that is indicative of a presence of a SDU sub-header subsequent to the first sub-header, or any combination thereof.

Aspect 13: The method of any of aspects 11 through 12, wherein the first sub-header comprises at least a portion of an identifier of the UE associated with the at least one contention-based random access message.

Aspect 14: The method of any of aspects 11 through 13, wherein the first sub-header, the first sub-payload, or both comprises an indication whether the UE should switch to a different power saving state.

Aspect 15: The method of aspect 14, wherein the first sub-payload indicates a contention resolution identity for the UE and refrains from indicating a timing advance command and a feedback configuration indicator based at least in part on the first sub-header, the first sub-payload, or both indicating for the UE to switch to a different power saving state.

Aspect 16: The method of any of aspects 14 through 15, wherein the first sub-payload indicates a contention resolution identity for the UE, a feedback configuration indicator, or both, and refrains from indicating a timing advance, a network identifier, or both.

Aspect 17: The method of any of aspects 11 through 16, wherein the first sub-header, the first sub-payload, or both comprises an indication of whether a feedback configuration is enabled within the first sub-payload.

Aspect 18: The method of aspect 17, wherein a quantity of bits for the feedback configuration within the first sub-payload is based at least in part on a quantity of UEs within the one or more UEs.

Aspect 19: The method of any of aspects 17 through 18, wherein the UE identifies a temporary network identifier for a feedback transmission in accordance with the feedback configuration based at least in part on a frame number corresponding to a transmission of the at least one contention-based random access message, a frame number of at least one response message, an index of a respective sub-header within the at least one response message, the feedback configuration, or any combination thereof.

Aspect 20: The method of any of aspects 1 through 19, wherein a first sub-payload of the payload portion of the at least one response message comprises a timing advance command that indicates a timing advance modification value.

Aspect 21: The method of any of aspects 1 through 20, further comprising: receiving, via a first sub-payload of the payload portion of the at least one response message, an indication of a radio network identifier for subsequent communications, the radio network identifier being based at least in part on a maximum quantity of carriers, an SFN, an H-SFN, or any combination thereof.

Aspect 22: The method of any of aspects 1 through 21, wherein the UE uses a first radio network identifier to transmit the at least one contention-based random access message that is a same radio network identifier or a different radio network identifier as a second radio network identifier that the UE uses to monitor for the at least one response message.

Aspect 23: The method of any of aspects 1 through 22, wherein the at least one contention-based random access message indicates a data signal transmission, a connection establishment request, or both.

Aspect 24: The method of any of aspects 1 through 23, wherein the at least one response message corresponds to the one or more UEs based at least in part on the at least one response message being a multicast message.

Aspect 25: The method of any of aspects 1 through 24, wherein the UE is a NB-IoT device.

Aspect 26: A UE for wireless communications, comprising a processing system that includes processor circuitry and memory circuitry that stores code, the processing system configured to cause the UE to perform a method of any of aspects 1 through 25.

Aspect 27: A UE for wireless communications, comprising at least one means for performing a method of any of aspects 1 through 25.

Aspect 28: A non-transitory computer-readable medium storing code for wireless communications, the code comprising instructions executable by one or more processors to perform a method of any of aspects 1 through 25.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, during a contention-based random access procedure and via at least one transmission occasion in a group of transmission occasions, at least one contention-based random access message using a resource from a set of resources of the at least one transmission occasion, the at least one contention-based random access message comprising a first message of the contention-based random access procedure; and
receive, during the contention-based random access procedure and in response to transmitting the at least one contention-based random access message, at least one response message that corresponds to one or more UEs that comprise the UE, the at least one response message comprising one or more sub-headers that are indicated consecutively and prior to a payload portion of the at least one response message, wherein the one or more sub-headers include one or more bits indicative of a sub-header type, and wherein the at least one response message comprises a second message of the contention-based random access procedure.

2. The UE of claim 1, wherein the one or more processors are individually or collectively further operable to execute the code to cause the UE to:
receive, via the one or more sub-headers indicated via the at least one response message, a first sub-header that comprises one or more bits indicating that the sub-header type of the first sub-header is a backoff indicator sub-header type, the one or more bits of the first sub-header comprising an indication of a first field with a corresponding value that is indicative of a presence of one or more additional sub-headers within the at least one response message, an indication of a second field with a corresponding value that is indicative of a backoff indicator, or a combination thereof, wherein the backoff indicator comprises an indication of a duration for the UE to retry the at least one contention-based random access message.

3. The UE of claim 1, wherein the one or more processors are individually or collectively further operable to execute the code to cause the UE to:
receive, via the one or more sub-headers indicated via the at least one response message, a first sub-header comprises one or more bits indicating that the sub-header type of the first sub-header is a contention-based random access message success sub-header type, the one or more bits of the first sub-header indicating that the first sub-header corresponds with a first sub-payload within the payload portion that comprises an indication of a successful reception of the at least one contention-based random access message.

4. The UE of claim 3, wherein the one or more bits of the first sub-header comprise an indication of a first field with a corresponding value that is indicative of a presence of one or more additional sub-headers within the at least one response message, an indication of a first value and a second value that provide a joint indication of a presence of a service data unit indicator, an indication of a second field with a corresponding value that is indicative of a presence of a service data unit sub-header subsequent to the first sub-header, or any combination thereof.

5. The UE of claim 3, wherein the first sub-header comprises at least a portion of an identifier of the UE associated with the at least one contention-based random access message.

6. The UE of claim 3, wherein the first sub-header, the first sub-payload, or both comprises an indication whether the UE should switch to a different power saving state during the contention-based random access procedure.

7. The UE of claim 6, wherein the first sub-payload indicates a contention resolution identity for the UE and refrains from indicating a timing advance command and a feedback configuration indicator based at least in part on the first sub-header, the first sub-payload, or both indicating for the UE to switch to the different power saving state.

8. The UE of claim 6, wherein the first sub-payload indicates a contention resolution identity for the UE, a feedback configuration indicator, or both, and refrains from indicating a timing advance, a network identifier, or both.

9. The UE of claim 3, wherein the first sub-header, the first sub-payload, or both comprises an indication of whether a feedback configuration is enabled within the first sub-payload.

10. The UE of claim 9, wherein the UE identifies a temporary network identifier for a feedback transmission in accordance with the feedback configuration based at least in part on a frame number corresponding to a transmission of the at least one contention-based random access message, a frame number of at least one response message, an index of a respective sub-header within the at least one response message, the feedback configuration, or any combination thereof.

11. The UE of claim 1, wherein a first sub-payload of the payload portion of the at least one response message includes a timing advance command that indicates a timing advance modification value.

12. The UE of claim 1, wherein the one or more processors are individually or collectively further operable to execute the code to cause the UE to:
receive, via a first sub-payload of the payload portion of the at least one response message, an indication of a radio network identifier for subsequent communications, the radio network identifier being based at least in part on a maximum quantity of carriers, a system frame number, a hyper-system frame number, or any combination thereof.

13. A method for wireless communications by a user equipment (UE), comprising:
transmitting, during a contention-based random access procedure and via at least one transmission occasion in a group of transmission occasions, at least one contention-based random access message using a resource from a set of resources of the at least one transmission occasion, the at least one contention-based random access message comprising a first message of the contention-based random access procedure; and
receiving, during the contention-based random access procedure and in response to transmitting the at least one contention-based random access message, at least one response message that corresponds to one or more UEs that comprise the UE, the at least one response message comprising one or more sub-headers that are indicated consecutively and prior to a payload portion of the at least one response message, wherein the one or more sub-headers include one or more bits indicative of a sub-header type, and wherein the at least one response message comprises a second message of the contention-based random access procedure.

14. The method of claim 13, further comprising:
receiving, via the one or more sub-headers indicated via the at least one response message, a first sub-header that comprises one or more bits indicating that the sub-header type of the first sub-header is a backoff indicator sub-header type, the one or more bits of the first sub-header comprising an indication of a first field with a corresponding value that is indicative of a presence of one or more additional sub-headers within the at least one response message, an indication of a second field with a corresponding value that is indicative of a backoff indicator, or a combination thereof, wherein the backoff indicator comprises an indication of a duration for the UE to retry the at least one contention-based random access message.

15. The method of claim 13, further comprising:
receiving, via the one or more sub-headers indicated via the at least one response message, a first sub-header comprises one or more bits indicating that the sub-header type of the first sub-header is a contention-based random access message success sub-header type, the one or more bits of the first sub-header indicating that the first sub-header corresponds with a first sub-payload within the payload portion that comprises an indication of a successful reception of the at least one contention-based random access message.

16. The method of claim 15, wherein the one or more bits of the first sub-header comprise an indication of a first field with a corresponding value that is indicative of a presence of one or more additional sub-headers within the at least one response message, an indication of a first value and a second value that provide a joint indication of a presence of a service data unit indicator, an indication of a second field with a corresponding value that is indicative of a presence of a service data unit sub-header subsequent to the first sub-header, or any combination thereof.

17. The method of claim 15, wherein the first sub-header comprises at least a portion of an identifier of the UE associated with the at least one contention-based random access message.

18. The method of claim 15, wherein the first sub-header, the first sub-payload, or both comprises an indication whether the UE should switch to a different power saving state during the contention-based random access procedure.

19. The method of claim 13, wherein a first sub-payload of the payload portion of the at least one response message includes a timing advance command that indicates a timing advance modification value.

20. A non-transitory computer-readable medium storing code for wireless communications, the code comprising instructions executable by one or more processors to:
transmit, during a contention-based random access procedure and via at least one transmission occasion in a group of transmission occasions, at least one contention-based random access message using a resource from a set of resources of the at least one transmission occasion, the at least one contention-based random access message comprising a first message of the contention-based random access procedure; and
receive, during the contention-based random access procedure and in response to transmitting the at least one contention-based random access message, at least one response message that corresponds to one or more user equipments (UEs) that comprises a UE that corresponds to the at least one contention-based random access message, the at least one response message comprising one or more sub-headers that are indicated consecutively and prior to a payload portion of the at least one response message, wherein the one or more sub-headers include one or more bits indicative of a sub-header type, and wherein the at least one response message comprises a second message of the contention-based random access procedure.
